(19) United States
(12) Patent Application Publication
(10) Pub. No.: US 2026/0008965 A1
(43) Pub. Date: Jan. 8, 2026

(54) HYDROPROCESSING OF BIO-CRUDE OIL WITH VEGETABLE AND/OR FATTY MATERIAL

(71) Applicant: TOPSOE A/S, Kgs. Lyngby (DK)

(72) Inventors: Magnus Zingler STUMMANN, Kgs. Lyngby (DK); Rasmus Thomas Rohde NIELSEN, Kgs. Lyngby (DK); Christian Ejersbo STREBEL, Kgs. Lyngby (DK)

(73) Assignee: TOPSOE A/S, Kgs. Lyngby (DK)

(21) Appl. No.: 18/997,244

(22) PCT Filed: Jun. 29, 2023
(86) PCT No.: PCT/EP2023/067791

§ 371 Date: Jan. 21, 2025

(30) Foreign Application Priority Data
Jul. 22, 2022 (EP) 22186442.4

(51) Int. Cl. C10G 49/00; B01J 19/24

(52) U.S. Cl. CPC C10G 49/00; B01J 19/245; C10G 2300/1011

(57) ABSTRACT

Process and plant for producing a hydrocarbon feed, comprising: providing a bio-crude oil feed comprising more than 10 wt % oxygen (O); supplying the bio-crude oil feed to a stabilization step in a stabilization reactor for producing a stabilized bio-crude oil feed comprising less O than said bio-crude oil feed; supplying the bio-crude oil feed or the optionally stabilized bio-crude oil feed to a hydrodoxygenation or deoxygenation (HDO/DO) step in a HDO/DO reactor, for producing a partly deoxygenated bio-crude oil feed comprising 2-10 wt % O; providing a vegetable oil and/or a fatty material feed; combining the partly deoxygenated bio-crude oil feed with the vegetable oil and/or a fatty material feed, for producing said hydrocarbon feed. The hydrocarbon feed may be further hydroprocessed into a hydrocarbon fuel.

The present invention relates to a process and plant for hydroprocessing of a bio-crude oil feed produced from the thermal decomposition of a solid feed stream, together with a vegetable and/or fatty material feed.

The co-processing hydrocarbon fuel feeds by combining a fossil fuel feed such as petroleum feed with a vegetable oil feed in hydroprocessing, is well-known. However, biocrude oils produced by thermal decomposition such as by pyrolysis, hydrothermal liquefaction (HTL) or solvolyis of a solid renewable feed, e.g. lignocellulosic biomass, are generally not miscible with vegetable oils and/or fatty materials including fatty acids, thus co-processing of these feeds in a hydroprocessing step such as hydrodeoxygenation (HDO) has so far been a significant challenge to overcome.

Stummann et al. “Hydrotreatment of Catalytic Fast Pyrolysis Oil to Renewable Fuels”, NAM27, The 27^{th} North American Catalysis Society Meeting, May 22-27, 2022 New York, NY, discloses a study where a Catalytic Fast Pyrolysis (CFP) oil is combined with a vegetable oil, here soy oil, in a stirred batch reactor.

Still, Applicant finds that vegetable oil is not miscible with most untreated catalytic pyrolysis oils, hence it is highly difficult to make it work in an industrial hydrotreating reactor. The hydrotreating reactor processing the co-feed will plug after few days when running at industrially relevant conditions.

It has now been found that despite that vegetable oil is not miscible with catalytic and non-catalytic pyrolysis and hydrothermal liquefaction (HTL) bio-crude oil, it is miscible in partly deoxygenated bio-crude oil, e.g. partly deoxygenated catalytic pyrolysis oil, having an oxygen content between 2 and 10 wt % oxygen (O), such as between 2 and 8 wt % O, or between 2 and 7 wt % O.

Accordingly, in a first general embodiment according to a first aspect of the invention, there is provided a process for producing a hydrocarbon feed, comprising the steps of:
providing a bio-crude oil feed comprising more than 10 wt % oxygen (O), for instance up to 70 wt % O or up to 60 wt % O;
supplying the bio-crude oil feed to a stabilization step in a stabilization reactor for producing a stabilized bio-crude oil feed comprising less O than said bio-crude oil feed;
supplying the stabilized bio-crude oil feed to a hydrodeoxygenation or deoxygenation (HDO/DO) step in a HDO/DO reactor, for producing a partly deoxygenated (partly upgraded) bio-crude oil feed comprising 2-10 wt % O and less O than said stabilized bio-crude oil feed;
providing a vegetable oil and/or a fatty material feed;
combining the partly deoxygenated bio-crude oil feed with the vegetable oil and/or a fatty material feed, for producing said hydrocarbon feed.

For instance, separate bio-crude oil feeds comprising more than 10 wt % oxygen (O) may be provided, or separate bio-crude oil feeds may be combined into a single bio-crude oil feed comprising more than 10 wt % oxygen (O).

For instance, the partly deoxygenated bio-crude oil feed(s) may be combined with a vegetable oil feed; or the partly deoxygenated bio-crude oil feed(s) may be combined with a fatty material feed such as an animal fat feed.

For instance, the partly deoxygenated bio-crude oil feed(s) may be combined first with a vegetable oil feed and then with a fatty material feed such as an animal fat feed. Optionally, an additional feed may be provided.

In an embodiment, the vegetable oil and/or fatty material feed is a non-hydroprocessed vegetable oil and/or fatty material feed. Thus, this feed has not been subjected to a prior hydroprocessing step such as hydrodeoxygenation (HDO).

Hence, the bio-crude oil feed is stabilized first and then partly deoxygenated, before mixing it with the vegetable oil and/or fatty material. By stabilizing the bio-crude oil and further removing its oxygen content to said specific range 2-10 wt %, it is now possible to combine it with vegetable oil and/or fatty material feed without the risk of plugging the HDO/DO reactor or any associated units such as pumps and heat exchangers. Further, the vegetable oil serves to cool the effluent from the HDO/DO reactor i.e. the partly deoxygenated bio-crude oil feed, or as cooling between the catalytic beds in a HDO reactor. Furthermore, the formation of a heavy end fraction in a downstream separation section is reduced, thereby increasing the production of e.g. diesel as hydrocarbon fuel. While an oxygen (O) content below 2 wt % in the bio-crude oil feed may contribute in rendering it miscible with the vegetable oil and/or fatty material, such low values of oxygen tend to be accompanied by low aromatic contents. As it will also be explained further below, the presence of aromatic compounds is desirable as this enables reducing the heavy end formation when producing and/or separating downstream a hydrocarbon product such as diesel and/or jet fuel. The present invention provides a partial deoxygenation with moderate severity of the bio-crude oil feed, i.e. so that the oxygen content of the thus partly deoxygenated (partly upgraded) bio-crude oil feed is 2-10 wt % O, while at the same time maintaining aromatic compounds therein. For instance, the content of aromatics may be 20-60 wt % aromatics (total), as measured according to ASTM D6591.

For the purposes of the present application, the term “first aspect of the invention” relates to the process. The term “second aspect of the invention” refers to the process plant, i.e. plant.

The term “present invention” and “present application” are used interchangeably.

The term “comprising” includes “comprising only”, i.e. “consisting of”.

The term “suitably” is used interchangeably with the term “optionally”, i.e. an optional embodiment.

The term “partly deoxygenated bio-crude oil feed” may be used interchangeably with the term “partly upgraded bio-crude oil feed”.

The term “bio-crude oil feed” means the liquid oil product of a thermal decomposition step in a thermal decomposition unit. The bio-crude oil feed may also be understood as an “advanced bio-crude” The thermal decomposition unit is a pyrolysis unit, a hydrothermal liquefaction (HTL) unit, or a solvolysis unit. The term “unit” is understood here as “reactor”.

The term “vegetable oil feed and/or fatty materials” includes vegetable oils such as soy oil, and fatty materials such as animal fat. The fatty materials include fatty acids.

The term “section”, for instance “hydroprocessing section”, means a physical section comprising a unit or combination of units for conducting one or more steps and/or substeps for producing a hydroprocessed feed.

The term “hydroprocessing” encompasses hydrotreating, thus hydrodeoxygenation or deoxygenation (HDO/DO). The term “hydroprocessing” encompasses also hydroisomerisation” (HDI), or hydrocracking (HCR), or hydrodearomatisation (HDA). It would be understood that a hydroprocessing step, such as a HDO/DO step is conducted in a hydroprocessing reactor such as HDO/DO reactor, or in a catalytic bed of the hydroprocessing reactor such as in a catalytic bed of the HDO/DO reactor. A hydroprocessing reactor may comprise one or more catalytic beds. Other definitions are recited below in connection with one or more embodiments of the invention.

In an embodiment, the bio-crude oil feed comprises at least 15 wt % O, or at least 30 wt % O, such as 35-70 wt % O, for instance 40-60 wt % O or 40-50 wt % O.

In principle, the higher the oxygen (O) content, the more reactive the bio-crude oil feed and thereby also the higher the tendency to form solid particles or polymerize and thus plug the HDO/DO reactor as well as associated units. For instance, the bio-crude oil feed may have the composition 45 wt % C, 9 wt % H and 46 wt % O, which is typical for a pyrolysis oil, while a typical vegetable oil such as soy oil may have the composition 79 wt % C, 12 wt % H and 12 wt % O.

In an embodiment, the bio-crude oil feed comprises 40-60 wt % O and the stabilized bio-crude oil feed comprises 20-55 wt % O.

Hence, suitably the content of oxygen in the stabilized bio-crude oil feed is −5% or −10% or −20% with respect to, i.e. relative to, the oxygen content of the bio-crude oil feed. For instance, the bio-crude oil feed may have 45 wt % O and the stabilized bio-crude oil feed may have 40 wt % O or 35 wt % O or 25 wt %.

Suitably, said combining step is with a weight ratio (A:B) of partly upgraded (partly deoxygenated) bio-crude oil feed (A) to vegetable oil and/or a fatty material feed (B) in the range: 9:1 i.e. wt % ratio of 90:10, to 1:9 i.e. wt % ratio of 10:90; such as 4:1 i.e. wt % ratio of 80:20, 3:1 i.e. wt % ratio of 75:25, 2:1 i.e. wt % ratio of 66.6:33.3, 1:1 i.e. wt % ratio of 50:50, 1:2 i.e. wt % 33.3:66.6, 1:3 i.e. wt % 25:75, 1:4 i.e. wt % 20:80, 1:5 i.e. wt % 17:83, 1:6 e.g. 1:5.7 i.e. wt % 15:85.

In an embodiment, the stabilization step is conducted in continuous operation mode in a fixed bed reactor comprising supplying the bio-crude oil feed with hydrogen in the presence of any of a: Ni—Mo, Co—Mo, Ni—Cu, Mo, Pt, Pd, Ru, or Ni based catalyst, at a temperature of 20-240° C., a pressure of 100-200 barg, optionally a liquid hourly space velocity (LHSV) of 0.1-1.1 h⁻¹, and a hydrogen to liquid oil ratio, defined as the volume ratio of hydrogen to the flow of the liquid oil stream (bio-crude oil feed), of 1000-6000 NL/L, such as 2000-5000 NL/L, thereby forming a stabilized bio-crude oil feed.

For instance, the catalyst is a Ni—Mo based catalyst, or a Co—Mo based catalyst, or a Ru/TiO₂ based catalyst (Ruthenium supported on titania), or Pt/TiO₂ based catalyst.

The term “Ni—Mo based catalyst”, “Co—Mo based catalyst”, or the like, means that Ni—Mo are the active elements of the catalyst.

Suitably, Ni—Mo, Co—Mo, or Mo are in sulfided form, e.g. NiMoS. Suitably also, Ni is in sulfided or reduced form.

By the term “stabilization” is meant converting carbonyl groups present in compounds of the liquid oil, such as aldehydes, ketones and acids, into alcohols. Other molecules such as sugars and furans may also be converted in the stabilization step. For instance, this stabilization step can be conducted by means of NiMo based catalysts, as disclosed in Shumeico et al. “Efficient one-stage bio-oil upgrading over sulfide catalysts”, ACS Sustainable Chem. Eng. 2020, 8, 15149-15167. Suitably, the stabilization is conducted according to the method disclosed in Applicant's co-pending European patent application Ser. No. 21152117.4 (corresponding to international application PCT/EP2022/050877).

As used herein, the term “stabilization” or “stabilization step”, as is also well-known in the art, means a step conducted in a stabilization reactor, in which e.g. the content of oxygen in a bio-crude oil feed is reduced for avoiding the formation of solid particles or polymerization which may plug HDO/DO units and associated equipment arranged downstream. As already recited, the content of oxygen (O content as wt %) in the stabilized bio-crude oil feed is for instance −5% or −10% or −20% with respect to the bio-crude oil feed.

Applicant has found that even when combining, i.e. co-processing, a bio-crude oil feed having a low oxygen content, for instance produced from Catalytic Fast Pyrolysis (CFP) having about 14 wt % O, with a typical vegetable oil having inherently a lower oxygen content e.g. about 11 wt % O, in a small hydrotreating unit (HDO unit), the unit plugged after a few days, hence some stabilization is needed before the catalytic pyrolysis oil is stable enough to be further hydrodeoxygenated.

Further, enabling proper miscibility of a bio-crude oil with e.g. vegetable oil is highly challenging, as there is no straightforward connection as such of miscibility with oxygen content of a bio-crude oil. For instance, as illustrated in the example (Example 1) farther below, the bio-crude oil samples that at first appear more miscible in vegetable oil, are the ones having highest content of oxygen (samples C and E).

In an embodiment, the process further comprises:
supplying said hydrocarbon feed to a subsequent HDO/DO step for producing a first hydroprocessed feed, e.g. hydrotreated feed; wherein said subsequent HDO/DO step is conducted in:
a downstream catalytic bed of said HDO/DO reactor producing said partly deoxygenated bio-crude oil feed; or
a downstream HDO/DO reactor.

The term “first hydroprocessed feed” may be used interchangeably with the term “hydrotreated feed” and signifies the effluent stream from the HDO/DO reactor treating the combined feeds (co-feed). It would by understood that although strictly speaking deoxygenation (DO) is without the presence, e.g. by addition, of hydrogen, for the purposes of the present application it is still regarded as a hydroprocessing step.

Thereby, several layouts are proposed; for instance:
the provision of at least two HDO/DO reactors, where the oxygen content is decreased to 2-10 wt % for pyrolysis oil and 2-8 wt % for HTL oil or solvolysis oil; a vegetable oil is then mixed with the product from the first HDO/DO reactor and the mixture is sent to the subsequent (second) HDO/DO reactor.
the provision of only one HDO/DO reactor and co-process a vegetable oil by feeding it to the lower beds in the HDO/DO reactor.

The present application makes it possible to co-process vegetable oils and/or fatty materials such as fatty acids, with HTL oil or pyrolysis oil or solvolysis oil, which is otherwise not possible. Further, the e.g. vegetable oil is used to cool the product from the first HDO/DO reactor or as cooling between the beds in the first HDO reactor. Furthermore, the effluent from HDO/DO of for instance HTL, i.e. the partly deoxygenated bio-crude oil feed comprising 2-10 wt % O may be highly aromatic, while the product from HDO of vegetable oil is highly paraffinic, thus co-processing leads to a better-quality diesel compared to HDO of only HTL oil, or only pyrolysis oil, or only solvolysis oil.

In an embodiment, the process further comprises:
supplying the first hydroprocessed feed, e.g. hydrotreated feed, to a subsequent hydroprocessing step in a downstream hydroprocessing section, such as a hydroisomerisation (HDI) step in a HDI reactor, and/or a hydrocracking (HCR) step in a HCR reactor, and/or a hydrodearomatization (HDA) step in a HDA reactor, for producing a second hydroprocessed feed.

The subsequent hydroprocessing step thus comprises treating the hydrotreated feed in one or more additional catalytic hydrotreating units under the addition of hydrogen, such as third catalytic hydrotreating unit or a cracking section. For instance, it would be understood that when a hydrocarbon product boiling in the jet fuel range is desired, a hydrocracking (HCR) unit is suitably used, for instance prior to passing the thus hydrotreated stream to HDI.

Normally a pyrolysis oil contains a high amount of oxygen compound and unsaturated hydrocarbon. During the hydrotreating of this feed, the oxygen is mainly removed as H₂O, which gives a fuel consisting of mainly naphthenes and aromatics. This is called the hydrodeoxygenation (HDO) pathway. Oxygen can also be removed by the decarboxylation pathway, which generates CO₂ instead of H₂O:
HDO pathway: RCH₂COOH+3H₂↔RCH₂CH₃+2H₂O
Decarboxylation pathway: RCH₂COOH↔RCH₃+CO₂

Further, while decarbonylation normally does not dominate in HDO of triglycerides in typical renewable feeds, it can be more dominant during HDO of pyrolysis oil:
Decarbonylation pathway: RCH₂COH+H₂<->RCH₃+CO

The material catalytically active in HDO (as used herein, interchangeable with the term hydrotreating), typically comprises an active metal (sulfided base metals such as nickel, cobalt, tungsten and/or molybdenum, but possibly also either elemental noble metals such as platinum and/or palladium) and a refractory support (such as alumina, silica or titania, or combinations thereof).

HDO conditions involve a temperature in the interval 250-400° C., a pressure in the interval 30-150 bar, and a liquid hourly space velocity (LHSV) in the interval 0.1-2, optionally together with intermediate cooling by quenching with cold hydrogen, feed or product.

The material catalytically active in hydroisomerization HDI typically comprises an active metal (either elemental noble metals such as platinum and/or palladium or sulfided base metals such as nickel, cobalt, tungsten and/or molybdenum), an acidic support (typically a molecular sieve showing high shape selectivity, and having a topology such as MOR, FER, MRE, MWW, AEL, TON and MTT) and a refractory support (such as alumina, silica or titania, or combinations thereof).

HDI conditions involve a temperature in the interval 250-400° C., a pressure in the interval 20-100 bar, and a liquid hourly space velocity (LHSV) in the interval 0.5-8.

The material catalytically active in hydrocracking (HCR) is of similar nature to the material catalytically active in isomerization, and it typically comprises an active metal (either elemental noble metals such as platinum and/or palladium or sulfided base metals such as nickel, cobalt, tungsten and/or molybdenum), an acidic support (typically a molecular sieve showing high cracking activity, and having a topology such as MFI, BEA and FAU) and a refractory support (such as alumina, silica or titania, or combinations thereof). The difference to material catalytically active isomerization is typically the nature of the acidic support, which may be of a different structure (even amorphous silica-alumina) or have a different acidity e.g. due to silica:alumina ratio.

HCR conditions involve a temperature in the interval 250-400° C., a pressure in the interval 30-150 bar, and a liquid hourly space velocity (LHSV) in the interval 0.5-8, optionally together with intermediate cooling by quenching with cold hydrogen, feed or product

The material catalytically active in HDA typically comprises an active metal (typically elemental noble metals such as platinum and/or palladium but possibly also sulfided base metals such as nickel, cobalt, tungsten and/or molybdenum) and a refractory support (such as amorphous silica-alumina, alumina, silica or titania, or combinations thereof).

HDA conditions involve a temperature in the interval 200-350° C., a pressure in the interval 20-100 bar or 20-200 bar, and a liquid hourly space velocity (LHSV) in the interval 0.5-8.

In an embodiment, the process comprises:
supplying the first hydroprocessed feed or the second hydroprocessed feed to a separation step in a separation section for producing a hydrocarbon product, said hydro-carbon product being any one of: naphtha, diesel, jet fuel, maritime (marine) fuel as a heavy end, or combinations thereof.

The maritime (marine) fuel is thus suitably withdrawn as the heavy end fraction.

In an embodiment, the weight ratio (A:B) of partly upgraded (partly deoxygenated) bio-crude oil feed (A) to vegetable oil and/or a fatty material feed (B) is in the range 1:1 i.e. 50:50 wt % (i.e. 1:1) to 10:90 wt % (i.e. 1:9), such as 20:80 wt % (i.e. 1:4) or 15:85 wt % (1:5.7); and optionally the subsequent HDO/DO step is conducted in continuous mode under the conditions: 250-400° C., such as 350-380° C., at a pressure of 50-150 bar, such as 100 bar, and with a fixed bed catalyst in which the catalyst is NiMoS and/or MoS.

At the above weight ratios (A:B) the best results in terms of cetane index and compliance with specifications (EN590 specs), are achieved. In addition, providing MoS catalyst, for instance by loading it on the top of the HDO/DO reactor, further reduces the heavy end formation.

It would be understood that the temperature of a given reactor refers to the inlet temperature in an adiabatic fixed bed reactor, or the reaction temperature in an isothermal reactor.

Suitably, the stabilization reactor and any of the hydroprocessing reactors such as a HDO/DO reactor or HDI or HCR reactor or HDA reactor, is an adiabatic fixed bed reactor.

The particular combination of co-processing, suitably in these weight ratios, and the provision of a NiMoS and/or MoS catalyst in the subsequent HDO/DO step, as recited above, enables reducing the heavy end fraction (C18+ formation). The yield of diesel this being the C15-C18 range, is thus increased.

The desirable hydrocarbon product downstream is, in an embodiment, diesel as a hydrocarbon product boiling the transportation fuel range, which is suitably represented by C15-C18 hydrocarbons. Hydrocarbons with carbon numbers above 18 (C18+) may be withdrawn downstream in the separation section as a heavy end fraction (herein also referred to as heavy end), yet it would be desirable to reduce this heavy end fraction for thereby increasing the yield of the C15-C18 fraction and thus the diesel fuel. It has been found that provision of the partly de-oxygenated bio-crude oil in the co-feed, for instance when provided in the wt range (50:50 wt % to 10:90 wt %) as recited above, there is lower production of the heavy end fraction, while still maintaining proper miscibility of the feeds. Without being bound by any theory, it is believed that the aromatics in the partly deoxygenated bio-crude oil feed act as a hydrogen donor and thereby decrease the heavy end formation. The conventional approach when dealing with a heavy end is to conduct hydrocracking of the heavy part of the product and thereby remove the heavy end. However, hydrocracking leads to a yield loss; thus, minimizing the heavy end formation increases the overall yield of the process, here in particular the diesel yield.

In another embodiment, the weight ratio (A:B) of partly upgraded (partly deoxygenated) bio-crude oil feed (A) to vegetable oil and/or a fatty material feed (B) is in the range 50:50 wt % to of 90:10 wt %; and optionally, any of the HDO/DO steps is conducted in continuous mode under the conditions: 250-400° C., e.g. 340-400° C., at a pressure of 50-150 bar, with a fixed bed catalyst in which the catalyst is NiMoS and/or MoS.

Hence, the weight ratio (A:B) of partly deoxygenated) bio-crude oil feed (A) to vegetable oil and/or a fatty material feed (B) is in the range: 50:50 wt % to 90:10 wt %, such as 80:20 wt % or 75:25 wt %. For instance, a mixture of 80 vol. % of hydrotreated catalytic fast pyrolysis oil as the partly deoxygenated bio-crude oil (A) and having an oxygen (O) content of about 2 wt %, with 20 vol. % of soybean oil as the vegetable oil (B), decreases the cloud and pour point of the mixture compared to a stand-alone hydrotreating of the soybean oil. This conveys the benefit that there is less need for hydroisomerization (HDI) and thus any associated yield loss during hydroisomerization is reduced. Associated capital expenses (CAPEX) and operating expenses (OPEX) for isomerization are thereby also reduced.

As is well known in the art, the cloud point of any petroleum product is an indicator of how well the hydrocarbon product, e.g. diesel, will perform under cold weather conditions. Pour point is the opposite of cloud point and refers to the lowest temperature where the movement of oil is observed so that the diesel can be pumped.

Suitably, a subsequent HDO/DO step is conducted in continuous mode under the conditions: 250-400° C., such as 350-380° C., at a pressure of 50-150 bar, such as 100 bar, and with a fixed bed catalyst in which the catalyst is NiMoS and/or MoS.

At the above weight ratios (A:B), for instance by combining a hydroprocessed, e.g. hydrotreated waste tyre pyrolysis oil and a hydrotreated vegetable oil, e.g. HVO, the resulting diesel shows desirable results in terms of cetane index and compliance with specifications (EN590 specs), including also improved cold flow properties in terms of cloud point. In addition, providing MoS catalyst, for instance by loading it on the top of the HDO/DO reactor, further reduces the heavy end formation.

In an embodiment, the process further comprises a thermal decomposition step of a solid feed stream in a thermal decomposition unit selected from a pyrolysis step in a pyrolysis unit (pyrolysis reactor) and a hydrothermal liquefaction (HTL) step in a HTL unit, or a solvolysis step in a solvolysis unit, thereby producing said bio-crude oil feed stream comprising more than 10 wt % O.

The thermal decomposition step is, in an embodiment, a pyrolysis step, such as a fast pyrolysis step.

The pyrolysis step may include the use of a pyrolysis unit such as fluidized bed, transported bed, or circulating fluid bed, as is well known in the art. For instance, the pyrolysis step may comprise the use of a pyrolysis unit (also referred herein as pyrolysis reactor), cyclone(s) to remove particulate solids such as char, and a cooling unit for thereby producing said first off-gas stream (i.e. pyrolysis off-gas) and said first liquid oil stream, i.e. condensed pyrolysis oil. This first off-gas stream comprises light hydrocarbons e.g. C1-C4 hydrocarbons, CO and CO₂. The first liquid oil stream is also referred to as pyrolysis oil or bio-oil and is a liquid substance rich in blends of molecules usually consisting of more than two hundred different compounds including aldehydes, ketones and/or other compounds such as furfural having a carbonyl group, resulting from the depolymerisation of products treated in pyrolysis.

For the purposes of the present invention, the pyrolysis step is preferably fast pyrolysis, also referred in the art as flash pyrolysis. Fast pyrolysis means the thermal decomposition of a solid renewable feedstock in the absence of oxygen, at temperatures in the range 350-650° C. e.g. about 500° C. and reaction times of 10 seconds or less, e.g. below 10 seconds, such as 5 seconds or less, e.g. about 2 seconds; i.e. the vapor residence time is 10 seconds or below, such as 2 seconds or less e.g. about 2 seconds.

Traditionally, fast pyrolysis may for instance also be conducted by autothermal operation e.g. in a fluidized bed reactor. The latter is also referred as autothermal pyrolysis and is characterized by employing air, optionally with an inert gas or recycle gas, as the fluidizing gas, or by using a mixture of air and inert gas or recycle gas. Thereby, the partial oxidation of pyrolysis compounds being produced in the pyrolysis reactor (autothermal reactor) provides the energy for pyrolysis while at the same time improving heat transfer. For details about autothermal pyrolysis, reference is given to e.g. “Heterodoxy in Fast Pyrolysis of Biomass” by Robert Brown: https://dx.doi.org/10.1021/acs.energyfuels.0c03512.

Thus, in an embodiment of the present application, the use of autothermal pyrolysis. i.e. autothermal operation, as a particular embodiment for conducting fast pyrolysis, is provided, i.e. the pyrolysis step is conducted by autothermal pyrolysis.

There are several types of fast pyrolysis where a catalyst is used. Sometimes an acid catalyst, such as a zeolite catalyst, is used in the pyrolysis unit (pyrolysis reactor) to upgrade the pyrolysis vapors; this technology is called catalytic fast pyrolysis (CFP) and can both be operated in an in-situ mode (the catalyst is located inside the pyrolysis unit), and an ex-situ mode (the catalyst is placed in a separate reactor; i.e. the pyrolysis gas is sent to a deoxygenation (DO) reactor for catalytically deoxygenating it prior to condensation of a pyrolysis oil, as described farther above). More specifically, in in-situ catalytic fast pyrolysis the catalyst is located inside the pyrolysis unit and the deoxygenation (through e.g. decarbonylation, decarboxylation by an acid-based catalyst such as a zeolite catalyst) takes place inside the pyrolysis reactor immediately after the pyrolysis vapours are formed. Suitable catalysts for CFP include alumina and all the types of zeolite catalysts that are normally used for hydrocracking (HCR) and cracking in refinery processes, such as HZSM-5. A more extensive list of catalytic material for HCR is provided farther below in the present application.

Similarly, in in-situ HDO (also called reactive catalytic fast pyrolysis, RCFP), a hydrotreating (HDO) catalyst is located in the pyrolysis unit, and the pyrolysis vapors are thereby hydrodeoxygenated immediately in the pyrolysis reactor after they are formed. Suitably catalysts for HDO are metal-based catalysts, including reduced Ni, Mo, Co, Pt, Pd, Re, Ru, Fe, such as CoMo or NiMo catalysits, suitably also in sulfide form: CoMoS, NiS, NiMoS, NiWS, RuS. The catalyst supports may be the same in conventional HDO in refinery processes, typically a refractory support such as alumina, silica or titania, or combinations thereof. Farther below in the present application, HDO conditions are also recited.

In ex-situ deoxygenation (DO), the vapors are deoxygenated in a separate DO reactor located after the pyrolysis unit. Thus, in ex-situ catalytic fast pyrolysis, the vapors are deoxygenated using an acid catalyst, such as a zeolite catalyst.

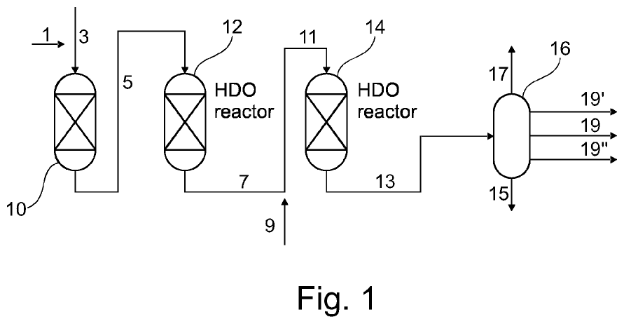

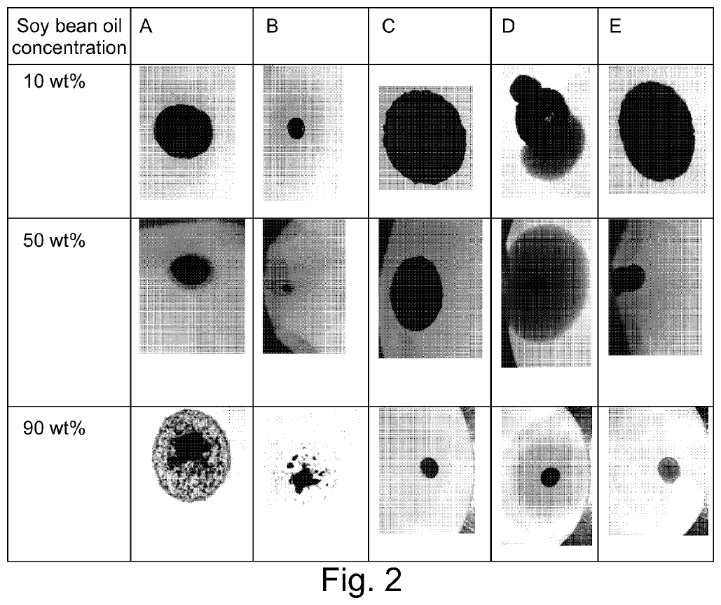

In ex-situ HDO, the pyrolysis vapors are hydrodeoxygenated in a separate HDO reactor located after the pyrolysis reactor using a hydrotreating catalyst, as for instance described in connection with FIGS. 1 and 2 farther below.

The use of a catalyst in the pyrolysis reactor conveys the advantage of lowering the activation energy for reactions thereby significantly reducing the required temperature for conducting the pyrolysis. In addition, increased selectivity towards desired pyrolysis oil compounds may be achieved.

It would be understood that where hydrogen is added to the catalytic fast pyrolysis, it is called reactive catalytic fast pyrolysis (RCFP). Further, if the catalytic fast pyrolysis is conducted at a high hydrogen pressure (˜>5 barg) it is often called catalytic hydropyrolysis (CHP). Hydropyrolysis (HP) means that hydrogen is added to the pyrolysis, yet at atmospheric pressure.

The pyrolysis step is suitably also a simple fast pyrolysis, which for the purposes of this application means fast pyrolysis being conducted without the presence of a catalyst and hydrogen in the pyrolysis unit, i.e. the fast pyrolysis is not any of: catalytic fast pyrolysis (CFP), hydropyrolysis (HP), reactive catalytic fast pyrolysis (RCFP) or catalytic fast hydropyrolysis (CHP). The pyrolysis unit may not include a HDO reactor downstream. This enables a much simpler and inexpensive process.

The table below summarizes the different options for fast pyrolysis apart from autothermal pyrolysis:

| | Hydrogen | Catalyst | HDO within | DO within or |
|---|---|---|---|---|
| Fast pyrolysis | added to pyrolysis | within pyrolysis | or outside | outside pyrolysis |
| type | unit | unit | pyrolysis unit | unit |
| Simple fast | no | no | outside | no |
| pyrolysis | | | (ex-situ HDO) | |
| Simple fast | no | no | no | no |
| pyrolysis | | | | |
| in-situ CFP | no | yes | no | Inside |
| | | (acid catalyst) | | |
| ex-situ CFP | no | no | no | outside |
| | | | | (ex-situ DO) |
| RCFP (in-situ | yes | yes | Inside | no |
| HDO) | | (HDO catalyst) | | |
| HP | yes | yes/no | outside | outside |
| CHP | yes, at high H₂ | As for RCFP, | As for RCFP, | As for RCFP, |
| | pressure | HP | HP | HP |
| | (>5 barg) | | | |

Accordingly, in an embodiment the pyrolysis step is fast pyrolysis, in which the vapor residence time is 10 seconds or less, e.g. below 10 seconds, such as 5 seconds or less, e.g. about 2 seconds, or 1 second, or in the range 1-5 seconds, and which is selected from: simple fast pyrolysis; in-situ catalytic fast pyrolysis (in-situ CFP); ex-situ catalytic fast pyrolysis (ex-situ CFP); reactive catalytic fast pyrolysis (RCFP); hydropyrolysis (HP); catalytic fast hydropyrolysis (CHP).

In another embodiment, the pyrolysis step is intermediate pyrolysis, in which the vapor residence time is in the range of 10 seconds-5 minutes, such as 11 seconds-3 minutes. As for fast pyrolysis, the temperature is also in the range 350-650° C. e.g. about 500° C. Often this pyrolysis is conducted in pyrolysis reactors handling different types of waste, where the vapor is burned after the pyrolysis reactor. Typical reactors are: Herreshoff furnace, rotary drums, amaron, CHOREN paddle pyrolysis kiln, auger reactor, and vacuum pyrolysis reactor.

In another embodiment, the pyrolysis step is slow pyrolysis, in which the solid residence time is in the range of 5 minutes-2 hours, such as 10 min-1 hour. The temperature is suitably about 300° C. This pyrolysis gives a high char yield and the char can be used as a fertilizer or as char coal; the pyrolysis still produces some gas and biocrude and if the carbon is used a fertilizer the final bio-oil can have a GHG above 100%, thus being carbon negative. Typical reactors are auger reactor—yet with a different residence time than for intermediate pyrolysis-, fixed bed reactor, kiln, lambiotte SI-FIC/CISR retort, Lurgi process, wagon reactor, and carbo twin resort.

In an embodiment, the thermal decomposition step is a hydrothermal liquefaction step. Hydrothermal liquefaction means the thermochemical conversion of biomass into liquid fuels by processing in a hot, pressurized water environment for sufficient time to break down the solid biopolymeric structure to mainly liquid components. Typical hydrothermal processing conditions are temperatures in the range of 250-375° C. and operating pressures in the range of 40-220 bar. This technology offers the advantage of operation of a lower temperature, higher energy efficiency and lower tar yield compared to pyrolysis, e.g. fast pyrolysis. For details on hydrothermal liquefaction of biomass, reference is given to e.g. Golakota et al., “A review of hydrothermal liquefaction of biomass”, Renewable and Sustainable Energy Reviews, vol. 81, Part 1, January 2018, p. 1378-1392.

In an embodiment, the thermal decomposition step is solvolysis. For the purposes of the present application, the term “solvolysis” means the heating of a lignocellulosic bio-mass in methanol or ethanol or other alcohol or a recycle oil, optionally also water, at a pressure in the range 20-80 bar, such as 40-60 bar, and at a temperature in the range 150-450° C., such as 150-200° C. or 325-425° C., to form a lignin derived bio-crude oil (solvolysis oil) as said bio-crude oil feed.

As is well-known in the art, solvolysis, a chemical reaction in which the solvent, such as methanol or ethanol optionally also water, is one of the reactants and is present in great excess of that required for the reaction. Where the solvent is specifically water, the solvolysis is hydrolysis. Hence, in a particular embodiment, the solvolysis step is hydrolysis.

In an embodiment, the thermal decomposition further comprises a preliminary step of passing said solid renewable feedstock through a solid renewable feedstock preparation section comprising for instance drying for removing water and/or comminution for reduction of particle size. Any water/moisture in the solid renewable feedstock which vaporizes in for instance the pyrolysis section condenses in the pyrolysis oil stream and is thereby carried out in the process, which may be undesirable. Furthermore, the heat used for the vaporization of water withdraws heat which otherwise is necessary for the pyrolysis. By removing water and also providing a smaller particle size in the solid renewable feedstock the thermal efficiency of the pyrolysis step is increased.

The preliminary step may also comprise conducting an acid wash for removing metals. This is particularly relevant for pyrolysis processes where the catalyst is located in the pyrolysis reactor. The removal of metals from the solid renewable feedstock increases the catalyst lifetime.

In an embodiment, the solid renewable feedstock comprises a lignocellulosic biomass including wood products, forestry waste, and agricultural residue. In an embodiment, the lignocellulosic biomass includes algae. In another embodiment, the solid renewable feedstock comprises a nitrogen-rich renewable feedstock such as manure or sewage sludge, in particular the organic portion thereof e.g. the organic portion of sewage sludge.

The term “sewage sludge” means the residual, semi-solid material that is produced as a by-product during sewage treatment of industrial or municipal wastewater; for instance, a dewatered sludge comprising: 50-70 wt % organic matter and 30-50 wt % mineral components (including 1-4 wt % of inorganic carbon), 1-10 wt % N, e.g. 3.4-4.0 wt % nitrogen (N), 0.5-2.5 wt % phosphorus (P).

In another embodiment the solid renewable feedstock comprises municipal waste, in particular the organic portion thereof.

For the purposes of the present application, the term “municipal waste” is interchangeable with the term “municipal solid waste” and means a feedstock containing materials of items discarded by the public, such as mixed municipal waste given the waste code 200301 in the European Waste Catalog (EWC code 20 03 01).

In another embodiment, the solid renewable feedstock comprises recycled solid waste in particular the organic portion thereof, where the recycled solid waste is defined as a feedstock containing materials of items discarded by the public, such as mixed recycled solid waste given in EU Directive 2018/2001 (RED II), Annex IX, Part A.

Hence, the renewable feedstock comprises one or more of:
a lignocellulosic biomass such as wood products, algae, forestry waste and/or agricultural residue;
nitrogen-rich renewable feedstock such as manure or sewage sludge;
municipal waste, in particular the organic portion thereof, where the municipal solid waste is defined as a feedstock containing materials of items discarded by the public, such as mixed municipal waste given the waste code 200301 in the European Waste Catalog (EWC code 20 03 01); and/or recycled solid waste, in particular the organic portion thereof, where the recycled solid waste is defined as a feedstock containing materials of items discarded by the public, such as mixed recycled solid waste given in EU Directive 2018/2001 (RED II), Annex IX, Part A.

In a particular embodiment, the lignocellulosic biomass is forestry waste and/or agricultural residue and comprises biomass originating from plants including grass such as nature grass (grass originating from natural landscape), wheat e.g. wheat straw, oats, rye, reed grass, bamboo, sugar cane or sugar cane derivatives such as bagasse, maize and other cereals.

Any combinations of the above are also envisaged.

As used herein, the term “lignocellulosic biomass” means a biomass containing, cellulose, hemicellulose and optionally also lignin. The lignin or a significant portion thereof may have been removed, for instance by a prior bleaching step.

In an embodiment, the process comprises feeding to the thermal decomposition unit:
a solid feed stream comprising at least 50 wt %, such as at least 60 wt %, or at least 70 wt % or at least 80 wt % or at least 90 wt %, of a solid renewable feedstock such as lignocellulosic biomass, municipal waste and/or recycled solid waste, for producing a pyrolysis oil stream, or a HTL oil stream, or a solvolysis oil stream, as said bio-crude oil feed comprising more than 10 wt % O.

In particular, it has been found that the hydrocarbon fuel diesel produced from a biocrude oil feed comprising more than 10 wt % O produced from the thermal decomposition of a lignocellulosic biomass, is rich in aromatics and the density and cetane index of the diesel fraction is therefore too high to fulfill EN590 diesel specifications. Hence, a significant problem associated with such advanced bio-crude oils is that they have so many aromatics that it is not necessarily enough to perform hydrodearomatization (HDA), because cycle alkanes also do not have the best cetane index, thus ring-opening by hydrocracking would be necessary. However, by co-processing it with e.g. vegetable oil it is now possible to minimize the hydrocracking and/or isomerization needed to get a good cetane index, such as a cetane index (CCI according to standard ASTM D4737), hereinafter also simply referred to as CCI, higher than 40, for instance 45-60, while at the same time increasing the diesel yield.

For instance, hydrotreated vegetable oil (HVO), or hydrotreated cooked oil (hydrotreated used cooking oil), has very high cetane index and low density but the cold flow properties are poor. The combination of e.g. bio-crude oil feed from the thermal decomposition of lignocellulosic biomass, in particular after said stabilization, with HVO or hydrotreated cooked oil, optionally with subsequent HDI, results in a particularly good diesel fuel in compliance with EN590 specs, including compliance with the desirable cold flow properties, e.g. in terms of cloud point (CP).

Accordingly, in an embodiment said vegetable oil and/or fatty material feed is a hydroprocessed, e.g. hydrotreated, vegetable oil and/or fatty material feed (e.g. hydrotreated vegetable oil feed and/or hydrotreated fatty material feed). The latter may be externally sourced, or internally sourced and thereby integrated in the process by the process further comprising subjecting the vegetable oil and/or fatty material to a hydroprocessing step, preferably a hydrotreating (HDO) step, prior to being combined with the partly deoxygenated bio-crude oil feed.

In an embodiment, said vegetable oil and/or fatty material feed is any of:
soy oil such as soy bean oil, rapeseed oil, corn oil, castor oil, cooked oil, animal fat such as beef, pork, milk, and chicken fat;
and combinations thereof.

For instance, said fatty material feed comprises fatty acids; the fatty material feed suitably being any of: triglycerides, diglycerides, monoglycerides, and free fatty acids.

When combining the partly deoxygenated bio-crude oil feed with the vegetable oil and/or a fatty material feed, for producing said hydrocarbon feed, additional feeds may be provided. Accordingly, in an embodiment, the step of combining the partly deoxygenated bio-crude oil feed with the vegetable oil and/or a fatty material feed, is further in combination with an additional feed; said additional feed suitably being:
a fossil feed, i.e. a feed originating from a fossil fuel source, such as such as diesel, kerosene, naphtha, and vacuum gas oil (VGO), and/or
an intermediate hydrocarbon product such as a recycle oil, i.e. by recycling an intermediate hydrocarbon product produced in the process, such as a portion of a hydroprocessed feed produced downstream, i.e. the first or second hydroprocessed feed.

Hence, suitably said intermediated hydrocarbon product produced in the process is a portion of the first or second hydroprocessed feed.

In an embodiment, the process further comprises supplying said diesel and said maritime (marine) fuel as a heavy end, or a combination thereof, to a hydroisomerisation (HDI) step in a HDI reactor, and/or a hydrocracking (HCR) step in a HCR reactor, for providing said intermediate hydrocarbon product, such as said intermediate hydrocarbon product produced in the process.

Hence, in the separation section, for instance in a distillation column therefrom and from which diesel and marine fuel are withdrawn, any of these hydrocarbon products or a portion thereof is supplied to HDI and/or HCR. Thereby, such hydrocarbon product, for instance maritime fuel which is hydroprocesed in the HCR reactor, is advantageously added after the partly deoxygenated bio-crude oil feed (which already has been subjected to stabilization and HDO/DO) has been combined with, suitably, the hydrotreated vegetable oil and/or a fatty material feed. A high synergy has been found by hydrotreating each of these streams separately as already described above.

In an embodiment, the process comprises a prior solvent-extraction step of the biocrude oil feed, such as a prior toluene-extraction step, for producing said bio-crude oil feed.

In a second general embodiment according to the first aspect of the invention, there is also provided a process for producing a hydrocarbon feed, comprising:
a hydrothermal liquefaction (HTL) step in a HTL unit, or a solvolysis step in a solvolysis unit, of a solid feed stream for producing a bio-crude oil feed stream comprising no more than 10 wt % O;
supplying the bio-crude oil feed to a hydrodoxygenation or deoxygenation (HDO/DO) step in a HDO/DO reactor, for producing a partly deoxygenated bio-crude oil feed comprising 2-8 wt % O;
providing a vegetable oil and/or a fatty material feed;
combining the partly deoxygenated bio-crude oil feed with the vegetable oil and/or a fatty material feed, optionally further in combination with an additional feed, for producing said hydrocarbon feed;
the process being absent of a stabilization step in a stabilization reactor prior to supplying the bio-crude oil feed to said HDO/DO step.

It has been found, that a HTL step or solvolysis step provides a bio-crude oil feed with a content of oxygen (O) as low as 11 wt %, or as low as 10 wt % or even lower, thus enabling stabilization of this feed. The provision of a stabilization reactor may thus be eliminated, thereby enabling also a simpler process and plant layout.

In a third general embodiment according to the first aspect of the invention, there is also provided a process for producing a hydrocarbon feed, comprising:
providing a bio-crude oil feed comprising more than 10 wt % oxygen (O);
supplying the bio-crude oil feed to a stabilization step in a stabilization reactor for producing a stabilized bio-crude oil feed comprising less O than said bio-crude oil feed;
supplying the stabilized bio-crude oil feed to a hydrodeoxygenation or deoxygenation (HDO/DO) step in a HDO/DO reactor, for producing a partly deoxygenated (partly upgraded) bio-crude oil feed comprising less than 10 wt % O and at least 0.1 wt % O, i.e. the bio-crude oil feed comprises between 0.1 and 10 wt % O, such as 0.1-9 wt % 0, 2-7 wt % O, 2-8 wt % O, 2-10 wt % O, and less O than said stabilized bio-crude oil feed;
providing a vegetable oil and/or a fatty material feed;
combining the partly deoxygenated bio-crude oil feed with the vegetable oil and/or a fatty material feed, optionally further in combination with an additional feed, for producing said hydrocarbon feed.

For instance, the partly deoxygenated bio-crude oil feed comprises any of 0.1, 0.5, 1.0, 1.5, 2.0, 2.5, 3.0, 3.5, 4.0, 4.5, 5.0, 5.5, 6.0, 6.5, 7.0, 7.5, 8.0, 8.5, 9.0 wt % O.

It would be understood that any of the embodiments according to the first general embodiment of the first aspect of the invention and associated benefits, may be used in connection with the second and third general embodiments of the first aspect of the invention.

In a second aspect, the invention envisages also a plant for conducting the process according to any of the above embodiments according to the first general embodiment of the first aspect of the invention.

The plant comprises:
a stabilization reactor arranged to receive a bio-crude oil comprising more than 10 wt % oxygen (O) and provide a stabilized bio-crude oil feed comprising less O than said bio-crude oil feed;
a hydrodeoxygenation or deoxygenation (HDO/DO) reactor (HDO/DO reactor) arranged to receive said stabilized bio-crude oil feed and provide a partly deoxygenated bio-crude oil feed comprising 2-10 wt % O and less O than said stabilized bio-crude oil feed;
a conduit providing a vegetable oil and/or a fatty material feed;
a mixing point, such as a mixing unit or junction, for combining the partly deoxygenated bio-crude oil feed with the vegetable oil and/or a fatty material feed, and providing a hydrocarbon feed.

In an embodiment, the stabilization reactor is arranged for continuous operation mode in a fixed bed reactor under the hydrogen addition, said fixed bed reactor comprising any of a Ni—Mo, Co—Mo, Ni—Cu, Mo, Pt, Pd, Ru, or Ni based catalyst; and the stabilization reactor further being arranged to operate at a temperature of 20-240° C., a pressure of 100-200 barg, optionally a liquid hourly space velocity (LHSV) of 0.1-1.1 h⁻¹, and a hydrogen to liquid oil ratio, defined as the volume ratio of hydrogen to the flow of the liquid oil stream, of 1000-6000 NL/L, such as 2000-5000 NL/L.

In an embodiment, the plant further comprises a downstream catalytic bed of said HDO/DO reactor, or a downstream HDO/reactor, and provide a first hydroprocessed feed.

In an embodiment, the plant further comprises a downstream hydroprocessing section arranged to receive said first hydroprocessed feed and provide a second hydroprocessed feed.

In an embodiment, the plant further comprises a separation section arranged to receive said first hydroprocessed feed or said second hydroprocessed feed and provide a hydrocarbon product, said hydrocarbon product being any one of: naphtha, diesel, jet fuel, maritime (marine) fuel as a heavy end, or combinations thereof.

In an embodiment, the plant further comprises a conduit providing an additional feed and which is arranged for combining with any of: the partly deoxygenated bio-crude oil feed, the vegetable oil and/or a fatty material feed; said additional feed being:
a fossil feed such as such as diesel, kerosene, naphtha, and vacuum gas oil (VGO), and/or
an intermediate hydrocarbon product such as a recycle oil, i.e. by recycling an intermediate hydrocarbon product produced in the plant, such as a portion of the first or second hydroprocessed feed.

In an embodiment, the plant further comprises: a HDI reactor, and/or a HCR reactor arranged to receive said diesel, said maritime (marine) fuel as a heavy end, or a combination thereof, and provide said intermediate hydrocarbon product, such as said intermediate hydrocarbon product produced in the plant.

The invention envisages also a plant for conducting the process according to the second general embodiment of the first aspect of the invention.

The plant comprises:
a hydrothermal liquefaction (HTL) unit, or a solvolysis unit, arranged to receive a solid feed stream for producing a bio-crude oil feed stream comprising no more than 10 wt % O;
a hydrodeoxygenation or deoxygenation (HDO/DO) reactor (HDO/DO reactor) arranged to receive said bio-crude oil feed stream and provide a partly deoxygenated bio-crude oil feed comprising 2-8 wt % O;
a conduit providing a vegetable oil and/or a fatty material feed;
a mixing point for combining the partly deoxygenated bio-crude oil feed with the vegetable oil and/or a fatty material feed, and providing a hydrocarbon feed.
the plant further being absent of a stabilization reactor upstream said HDO/DO reactor, i.e. no stabilization reactor is arranged between said HTL unit or solvolysis unit, and said HDO/DO reactor.

It would also be understood that any of the embodiments according to the first aspect of the invention and associated benefits, may be used in connection with the second aspect of the invention.

FIG. 1 shows a schematic layout of the process and plant according to an embodiment of the invention.

FIG. 2 is in accordance with Example 1, and shows a spot test of different concentrations of soy bean oil with different bio-crude oils (A-E).

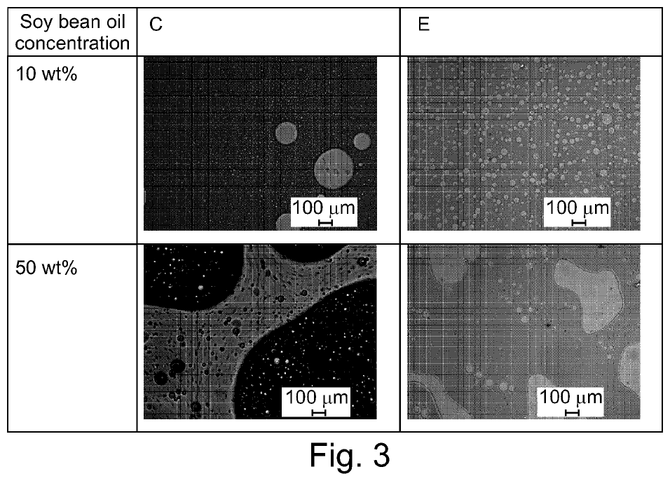

FIG. 3 is in accordance with Example 1, and shows microscope pictures of different soy bean oil mixtures with bio-crude oils C and E.

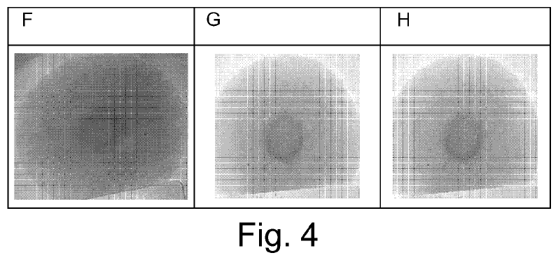

FIG. 4 is in accordance with Example 1, and shows a spot test of 50 wt % soy bean oil in bio-crude oils F, G, and H.

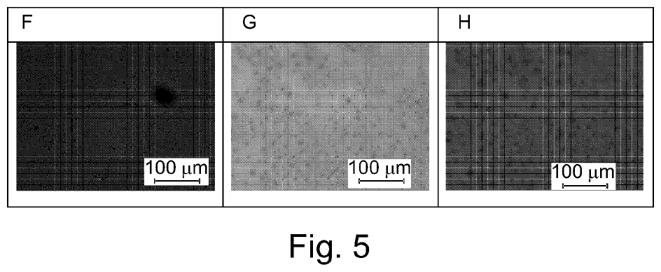

FIG. 5 is in accordance with Example 1, and shows microscope pictures of 50 wt % soy bean oil with bio-crude oils F, G, and H.

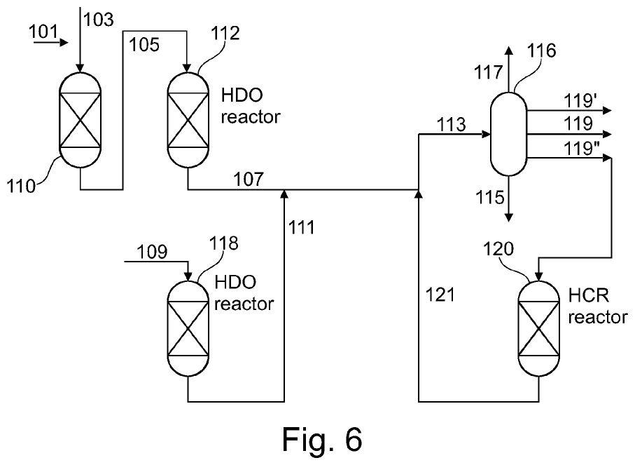

FIG. 6 shows another schematic layout of the process and plant according to an embodiment of the invention.

With reference to FIG. 1, a process/plant (process and/or plant) is shown in accordance with an embodiment of the present invention. Bio-crude oil feed 1 for instance comprising 45 wt % O is fed together with hydrogen 3 to a stabilization reactor 10 operated at e.g. 80-250° C. thereby producing a stabilized bio-crude oil feed 5 comprising less O than the bio-crude oil feed 1; for instance, 40 wt % O. The stabilized bio-crude oil feed 5 is supplied to a HDO/DO reactor 12 for producing a partly deoxygenated bio-crude oil feed 7 comprising 2-10 wt % O, for instance 2-7 wt % O. A vegetable oil and/or a fatty material feed 9 is provided and combined with the partly deoxygenated bio-crude oil feed 7 to produce hydrocarbon feed 11. The hydrocarbon feed 11 is supplied to a subsequent HDO/DO reactor 14 thereby producing a first hydroprocessed feed 13, which may then be supplied to a subsequent hydroprocessing step in e.g. a downstream hydroprocessing section (not shown). In a further downstream separation section, here schematically illustrated by separator 16, a hydrocarbon product is produced, such as diesel 19 as well as naphtha 19′ and heavy end 19″. A water stream 15 as well as off-gas stream 17 comprising NH₃, H₂S and C₁₋₄ hydrocarbons is also withdrawn.

With reference to FIG. 6, a process/plant (process and/or plant) is shown in accordance with another embodiment of the present invention. Bio-crude oil feed 101 for instance comprising 45 wt % O is fed together with hydrogen 103 to a stabilization reactor 110 operated at e.g. 80-250° C. thereby producing a stabilized bio-crude oil feed 105 comprising less O than the bio-crude oil feed 101; for instance, 40 wt % O. The stabilized bio-crude oil feed 105 is supplied to a HDO/DO reactor 112 for producing a partly deoxygenated bio-crude oil feed 107 comprising 2-10 wt % O, for instance 2-7 wt % O. A vegetable oil and/or a fatty material feed 109 is provided, hydrotreated in HDO/DO reactor 118 thereby producing a hydrotreated vegetable oil and/or fatty material feed 111, and then combined with the partly deoxygenated bio-crude oil feed 107. An additional feed, such as intermediate hydrocarbon product 121 produced in the process, is further combined thereby producing hydrocarbon feed 113, which may then be supplied to a subsequent hydroprocessing step in e.g. a downstream hydroprocessing section (not shown). In downstream separation section, here also schematically illustrated by separator 116, hydrocarbon product is produced, such as diesel 119 as well as naphtha 119′ and heavy end 119″. A water stream 115 as well as off-gas stream 117 comprising NH₃, H₂S and C₁₋₄ hydrocarbons is also withdrawn. The heavy end 119″ is hydrocracked in HCR reactor 120 to produce the intermediate hydrocarbon product 121. A HDI reactor (not shown) may also be provided instead of the HCR reactor or in addition to the HCR reactor for producing the intermediate hydrocarbon product 121. The stabilized bio-crude oil feed 105, the vegetable oil and/or fatty material feed 109, and heavy end stream 119″ are thus hydrotreated separately prior to being combined into the hydrocarbon feed 113.

### Example 1

Miscibility of bio-crude oils and vegetable oil (soy bean oil).

The composition of the used soy bean oil is shown in Table 1.

TABLE 1
Composition of used soy bean oil (measured
with an elemental analyzer)

| C | H | O |
|---|---|---|
| (wt %) | (wt %) | (wt %) |
| 78 | 12 | 12 |

An overview of the used bio-crude oil feeds (bio-crude oil) are shown in the below table:

TABLE 2
Bio-crude oil feeds

| | | Bio-crude oil | | | | |
|---|---|---|---|---|---|---|
| | | A | B | C | D | E |
| | | Description | | | | |
| | | Toluene extracted | Catalytic | Stabilized | | |
| | | catalytic | pyrolysis | pyrolysis | HTL | Pyrolysis |
| | | pyrolysis oil | oil | oil | oil | oil |
| C (wt %) | E.A.* | 67 | 77 | 54 | 82 | 45 |
| H (wt %) | E.A.* | 7.0 | 7.6 | 8.6 | 8.7 | 8.8 |
| O (wt %) | E.A.* | 26 | 15 | 39 | 11 | 46 |

*E.A.: Elemental Analysis

The miscibility was first tested by using a spot test for visual detection of miscibility, which was conducted by mixing the biocrude oils with soy bean oil and one droplet of the mixture was added to a filter. The spot test for visual detection of miscibility is a Compatibility Test as e.g. used in P. Manara et al, “Study on phase behavior and properties of binary blends of bio-oil/fossil-based refinery intermediates: A step toward bio-oil refinery integration”; Energy Conversion and Management 165 (2018) 304-315.

As shown in FIG. 2, biocrude oil A, B and D were not miscible in soy bean oil, while biocrude oil C and E appear on a macroscopic level miscible with soy bean oil. The biocrude oils C and E have the highest content of oxygen (O) and yet appear to be the most miscible in vegetable oil.

It should be noted that mixing biocrude oil A and B with soy bean oil leads to precipitation of solids, thus co-processing these feeds with soy bean oil in an industrial or pilot unit would lead to rapid blocking of the reactor and the pipes.

However, the 10 wt % and 50 wt % soy bean oil in bio-crude oil C and E were studied using an optical microscope, which showed that it is not miscible in bio-crude oil C and E; see FIG. 3.

The miscibility of three (3) partly deoxygenated (via HDO) catalytic pyrolysis oils was also investigated and their compositions are shown in Table 3. The results from the spot test and the optical microscope are shown in FIG. 4 and FIG. 5, which show that these partly deoxygenated bio-crude oils having an oxygen content in the range 2-10 wt %, such as 2-8 wt %, are miscible with soy bean oil when using a weight ratio of 1:1(50 wt % soy bean oil). Lower weight ratios such as 1:9 (10 wt % partly deoxygenated bio-crude oil and 90 wt % soy bean oil) may increase miscibility.

TABLE 3
Hydrotreated catalytic pyrolysis oils

| | | F | G | H |
|---|---|---|---|---|
| C (wt %) | E.A.* | 81 | 81 | 83 |
| H (wt %) | E.A.* | 11 | 10 | 11 |
| O (wt %) | E.A.* | 5.9 | 7.3 | 5.2 |

*E.A: Elemental Analysis

Thus, it is possible to co-process vegetable oils and fatty acids with advanced biofuels i.e. bio-crude oils, by first decreasing the oxygen content in the advanced biofuels to 10-2 wt % by partial deoxygenation e.g. with moderate severity, after which they become miscible with vegetable oil. At this moderate severity a high concentration of aromatics is maintained, which reduces the production of heavy ends.

### Example 2

Co-processing of soybean oil with hydrotreated catalytic fast pyrolysis (CFP) oil

A soybean oil with a cloud and pour point of −7.3 and −12.0° C. was hydrotreated in a fixed bed once-through hydrotreating unit. The produced hydrotreated soybean oil had a cloud point of 22.7° C. and a pour point of 21.0° C. Blending the soybean oil with a hydrotreated catalytic fast pyrolysis oil (ratio 20/80 v/v), decreased the cloud and pour point of the feed to −15.0 and −12.0° C., respectively. The cloud and pour point of the hydrotreated oil also decreased to 17.3 and 18.0° C., respectively. The cloud and pour point of the feeds and products are shown in Table 4 and the oxygen, hydrogen and specific gravity (SG) are shown in Table 5. It was not possible to measure the cloud and pour point of the used hydrotreated catalytic fast pyrolysis oil because it was too dark for the method. However, it was possible to measure the cloud and pour point of another similar oil (hydrotreated in the same experiment). This oil had a cloud and pour point of −19.9 and −21.0° C. and the oxygen content was 1.5 wt %.

This shows that co-processing of soybean oil and hydrotreated catalytic fast pyrolysis decreases the cloud and pour point compared to stand-alone hydrotreating of soybean oil, hence the co-processing decreases the need for isomerization, thus also decreasing the yield loss associated with isomerization.

TABLE 4

| Analysis | T Cloud | T Pour |
|---|---|---|
| Unit | ° C. | ° C. |
| Method | D 5773 | D 5773 |
| Soybean oil | −7.3 | −12.0 |
| 20/80 v/v hydrotreated catalytic | −15.0 | −21.0 |
| fast pyrolysis oil/soybean oil | | |
| Hydrotreated soybean oil | 22.7 | 21.0 |
| Hydrotreated 20/80 v/v hydrotreated | 17.3 | 18.0 |
| catalytic fast pyrolysis oil/soybean oil | | |

TABLE 5

| | | O | |
|---|---|---|---|
| Analysis | H | wt % | SG @ |
| Unit | wt % | Elemental | 60/60° F. |
| Method | D 7171 | analysis | D 4052 |
| Soybean oil | 11.49 | 11.0 | 0.9236 |
| Hydrotreated catalytic | 10.47 | 1.8 | 0.9327 |
| fast pyrolysis oil | | | |
| 20/80 v/v hydrotreated | 11.29 | 8.0 | 0.9256 |
| catalytic fast | | | |
| pyrolysis oil/soybean oil | | | |

We claim:

1. Process for producing a hydrocarbon feed, comprising the steps of:
providing a bio-crude oil feed comprising more than 10 wt % oxygen (O);
supplying the bio-crude oil feed to a stabilization step in a stabilization reactor for producing a stabilized bio-crude oil feed comprising less O than said bio-crude oil feed;
supplying the stabilized bio-crude oil feed to a hydrodeoxygenation or deoxygenation (HDO/DO) step in a HDO/DO reactor, for producing a partly deoxygenated bio-crude oil feed comprising 2-10 wt % O and less O than said stabilized bio-crude oil feed;
providing a vegetable oil and/or a fatty material feed;
combining the partly deoxygenated bio-crude oil feed with the vegetable oil and/or a fatty material feed, for producing said hydrocarbon feed.

2. Process according to claim 1, wherein the bio-crude oil feed comprises at least 15 wt % O.

3. Process according to claim 1, wherein the bio-crude oil feed comprises 40-60 wt % O and the stabilized bio-crude oil feed comprises 20-55 wt % O.

4. Process according to claim 1, wherein the stabilization step is conducted in continuous operation mode in a fixed bed reactor, the process comprising contacting the bio-crude oil feed with hydrogen in the presence of any of a: Ni—Mo, Co—Mo, Ni—Cu, Mo, Pt, Pd, Ru, or Ni based catalyst, at a temperature of 20-240° C., a pressure of 100-200 barg, and a hydrogen to liquid oil ratio, defined as the volume ratio of hydrogen to the flow of the liquid oil stream, of 1000-6000 NL/L, thereby forming said stabilized bio-crude oil feed.

5. Process according to claim 1, further comprising:
supplying said hydrocarbon feed to a subsequent HDO/DO step for producing a first hydroprocessed feed; wherein said subsequent HDO/DO step is conducted in:
a downstream catalytic bed of said HDO/DO reactor producing said partly deoxygenated bio-crude oil feed; or a downstream HDO/DO reactor.

6. Process according to a claim 1, further comprising:
supplying the first hydroprocessed feed to a subsequent hydroprocessing step in a downstream hydroprocessing section, such as a hydroisomerisation (HDI) step in a HDI reactor, and/or a hydrocracking (HCR) step in a HCR reactor, and/or a
hydrodearomatization (HDA) step in a HDA reactor, for producing a second hydroprocessed feed.

7. Process according to an claim 5, comprising:
supplying the first hydroprocessed feed or the second hydroprocessed feed to a separation step in a separation section for producing a hydrocarbon product, said hydrocarbon product being any one of: naphtha, diesel, jet fuel, maritime (marine) fuel as a heavy end, or combinations thereof.

8. Process according to claim 1, wherein the weight ratio (A:B) of partly deoxygenated bio-crude oil feed (A) to vegetable oil and/or a fatty material feed (B) is in the range 50:50 wt % to 10:90 wt %.

9. Process according to claim 1, wherein the weight ratio (A:B) of partly deoxygenated) bio-crude oil feed (A) to vegetable oil and/or a fatty material feed (B) in the range: 50:50 wt % to 90:10 wt %.

10. Process according to claim 1, further comprising a thermal decomposition step of a solid feed stream in a thermal decomposition unit selected from a pyrolysis step in a pyrolysis unit, a hydrothermal liquefaction (HTL) step in a HTL unit, or a solvolysis step in a solvolysis unit, thereby producing said bio-crude oil feed comprising more than 10 wt % O.

11. Process according to claim 10, wherein the process comprises feeding to the thermal decomposition unit:
a solid feed stream comprising at least 50 wt % of a solid renewable feedstock for producing a pyrolysis oil stream, or a HTL oil stream, or a solvolysis oil stream, as said bio-crude oil feed comprising more than 10 wt % O.

12. Process according to claim 1, wherein said vegetable oil and/or fatty material feed is a hydroprocessed vegetable oil and/or fatty material feed.

13. Process according to claim 1, wherein said vegetable oil and/or fatty material feed is any of: soy oil, rapeseed oil, com oil, castor oil, cooked oil, animal fat, and combinations thereof.

14. Process according to claim 1, wherein the step of combining the partly deoxygenated bio-crude oil feed with the vegetable oil and/or a fatty material feed, is further in combination with an additional feed; said additional feed being:
a fossil feed and/or
an intermediate hydrocarbon product.

15. Process according to claim 7, wherein the process further comprises supplying said diesel said maritime (marine) fuel as a heavy end, or a combination thereof, to a hydroisomerisation (HDI) step in a HDI reactor, and/or a hydrocracking (HCR) step in a HCR reactor, for providing said intermediate hydrocarbon product.

16. Process for producing a hydrocarbon feed, comprising:
a hydrothermal liquefaction (HTL) step in a HTL unit, or a solvolysis step in a solvolysis unit, of a solid feed stream for producing a bio-crude oil feed stream comprising no more than 10 wt % O;
supplying the bio-crude oil feed to a hydrodoxygenation or deoxygenation (HDO/DO) step in a HDO/DO reactor, for producing a partly upgraded (partly deoxygenated) bio-crude oil feed comprising 2-8 wt % O;
providing a vegetable oil and/or a fatty material feed;
combining the partly deoxygenated bio-crude oil feed with the vegetable oil and/or a fatty material feed for producing said hydrocarbon feed;
the process being absent of a stabilization step in a stabilization reactor prior to supplying the bio-crude oil feed to said HDO/DO step.

17. Plant for conducting the process according to a claim 1, comprising:
a stabilization reactor arranged to receive a bio-crude oil comprising more than 10 wt % oxygen (O) and provide a stabilized bio-crude oil feed comprising less O than said bio-crude oil feed;
a hydrodeoxygenation or deoxygenation (HDO/DO) reactor (HDO/DO reactor) arranged to receive said stabilized bio-crude oil feed and provide a partly deoxygenated bio-crude oil feed comprising 2-10 wt % O and less O than said stabilized bio-crude oil feed;
a conduit providing a vegetable oil and/or a fatty material feed;
a mixing point for combining the partly deoxygenated bio-crude oil feed with the vegetable oil and/or a fatty material feed, and providing a hydrocarbon feed.

18. Plant for conducting the process according to claim 17, comprising:
a hydrothermal liquefaction (HTL) unit, or a solvolysis unit, arranged to receive a solid feed stream for producing a bio-crude oil feed stream comprising no more than 10 wt % O;
a hydrodeoxygenation or deoxygenation (HDO/DO) reactor (HDO/DO reactor) arranged to receive said bio-crude oil feed stream and provide a partly deoxygenated bio-crude oil feed comprising 2-8 wt % O;
a conduit providing a vegetable oil and/or a fatty material feed;
a mixing point for combining the partly deoxygenated bio-crude oil feed with the vegetable oil and/or a fatty material feed, and providing a hydrocarbon feed;
the plant further being absent of a stabilization reactor upstream said HDO/DO reactor.

19. The process of claim 4 wherein the bio-crude oil feed is contacted with the hydrogen in the presence of the catalyst at a liquid hourly space velocity (LHSV) of 0.1-1.1 h⁻¹.

20. The process of claim 8, wherein the HDO/DO step for producing the first hydroprocessed feed is conducted in continuous mode under the conditions: 250-400° C., at a pressure of 50-150 bar, with a fixed bed catalyst in which the catalyst is NiMoS and/or MoS.

21. The process of claim 14, wherein said additional feed is an intermediate hydrocarbon product produced by recycling an intermediate hydrocarbon product produced in the process.

22. The process of claim 21, wherein the intermediate hydrocarbon product is produced by recycling a portion of the first or second hydroprocessed feed.
